(19) United States
(12) Patent Application Publication
(10) Pub. No.: US 2006/0212877 A1
(43) Pub. Date: Sep. 21, 2006

(54) Cancellation mechanism

(75) Inventors: Brian M. Grunkemeyer, Redmond, WA (US); Christopher W. Brumme, Mercer Island, WA (US); Christopher S. George, Issaquah, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/061,923

(22) Filed: Feb. 17, 2005

(51) Int. Cl. G06F 9/46

(52) U.S. Cl. 719/313

(57) ABSTRACT

IO operations or processor-intensive operations may be canceled, interrupted, or otherwise terminated without corrupting an overriding process.

### DRAWINGS

The detailed description refers to the following drawings.

FIG. 1 shows a network environment in which examples of a cancellation mechanism may be implemented.

FIG. 2 shows an example of at least a portion of a program for which at least one implementation of a cancellation mechanism may be applied.

FIG. 3 shows an example of a portion of a stack that may be used in correspondence to at least one implementation of a cancellation mechanism.

FIG. 4 shows a processing flow in accordance with at least one example implementation of a cancellation mechanism.

### DETAILED DESCRIPTION

A cancellation mechanism is described herein.

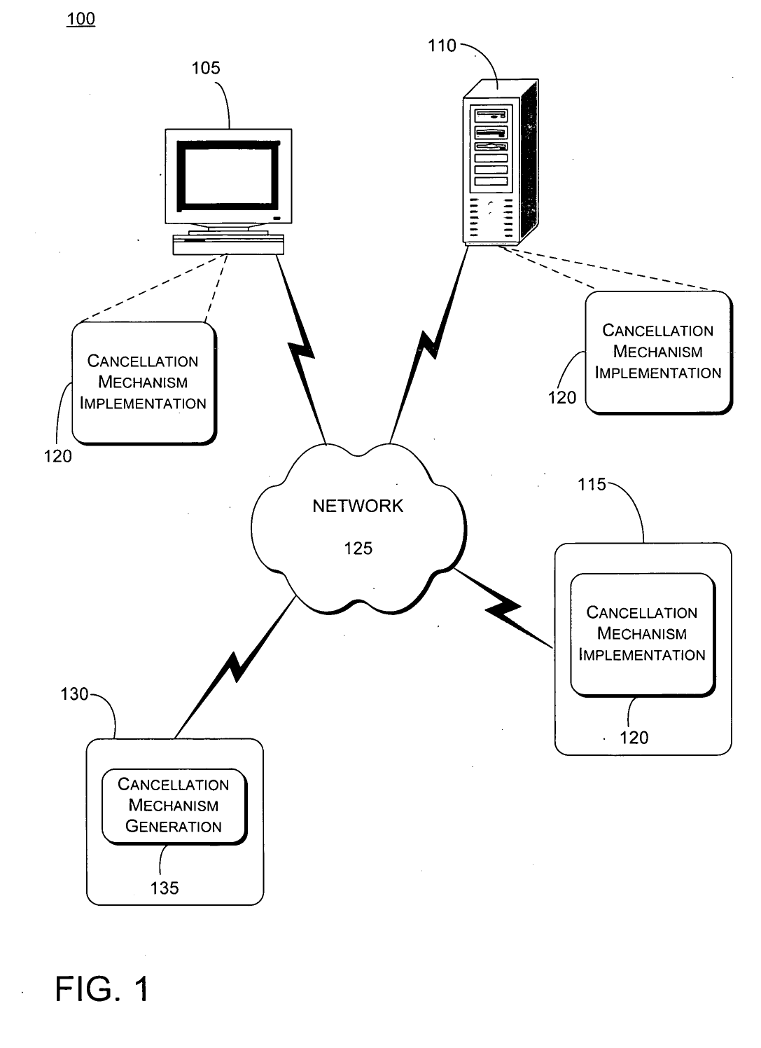

FIG. 1 shows an example network environment in which a cancellation mechanism may be implemented, with the devices being communicatively coupled in either an off-line manner or by network 125.

More particularly, any one of client device 105, server device 110, “other” device 115, and data source 130 may be capable of implementing one or more aspects of cancellation mechanism implementation 120, as described herein. Thus, on any of devices 105, 110, 115, and 130, execution of an application, program, function, or other assemblage of programmable and executable code may be canceled, interrupted, or otherwise terminated in accordance with one or more of the examples described herein.

Client device 105 may be at least one of a variety of conventional computing devices, including a desktop personal computer (PC), workstation, mainframe computer, Internet appliance, set-top box, and gaming console. Further, client device 105 may be at least one of any device that is capable of being associated with network 125 by a wired and/or wireless link, including a personal digital assistant (PDA), laptop computer, cellular telephone, etc. Further still, client device 105 may represent the client devices described above in various quantities and/or combinations thereof. “Other” device 115 may also be embodied by any of the above examples of client device 105.

Server device 110 may provide any of a variety of data and/or functionality to client device 105 or “other” device 115. The data may be publicly available or alternatively restricted, e.g., restricted to only certain users or only if an appropriate subscription or licensing fee is paid. Server device 110 is at least one of a network server, an application server, a web blade server, or any combination thereof. Typically, server device 110 is any device that is the source of content, and client device 105 is any device that receives such content either via network 125 or via an off-line medium. However, according to the example implementations described herein, server device 105 and client device 110 may interchangeably be a sending host or a receiving host. “Other” device 115 may also be embodied by any of the above examples of server device 110.

“Other” device 115 may further be any device that is capable of cancellation mechanism implementation 120 according to one or more of the examples described herein. That is, “other” device 115 may be any software-enabled computing or processing device that is capable of implementing at least one aspect of a cancellation mechanism as it may pertain to an application, program, function, or other assemblage of programmable and executable code, in either of a managed execution environment or a testing environment. Thus, “other” device 115 may be a computing or processing device having at least one of an operating system, an interpreter, converter, compiler, or managed execution environment implemented thereon. These examples are not intended to be limiting in any way, and therefore should not be construed in such manner.

Network 125 may represent any of a variety of conventional network topologies, which may include any wired and/or wireless network. Network 125 may further utilize any of a variety of conventional network protocols, including public and/or proprietary protocols. For example, network 125 may include the Internet, an intranet, or at least portions of one or more local area networks (LANs).

Data source 130 may represent any one of a variety of conventional computing devices, including a desktop personal computer (PC), that may be capable of generating 135 at least one cancellation mechanism in connection with code for an application, program, function, or other assemblage of programmable and executable code, which may or may not be object-oriented code. Alternatively, data source 130 may also be any one of a workstation, mainframe computer, Internet appliance, set-top box, gaming console, personal digital assistant (PDA), laptop computer, cellular telephone, etc., that may be capable of transmitting at least a portion of an application, program, or function to another work station. Further, although data source 130 may be a source of code for the application, program, or function, data source 130 may be regarded as at least the source of a cancellation mechanism, an identifier of the cancellation mechanism, or at least an expression of a cancellation mechanism identifier. Regardless of the implementation, the cancellation mechanism, cancellation mechanism identifier, or expression of the cancellation mechanism identifier, may be transmitted from data source 130 to any of devices 105, 110, and 115 as part of an on-line notification via network 125 or as part of an off-line notification.

Cancellation mechanism implementation 120 may enable the cancellation, interruption, or termination of a synchronous input/output (hereafter “IO”) operation after the IO operation has begun execution but before the execution has been completed. Non-limiting examples of such synchronous IO operations include, but are in no way limited to, a data query, creation of a file, reading of a file, writing of a file, or an attempt to access network data.

Further, a managed execution environment may be an appropriate environment for cancellation mechanism implementation 120, wherein a race condition may impede cancellation of an intended synchronous operation. That is, it is desirable that cancellation, interruption, or termination of a synchronous IO operation in, e.g., a managed execution environment be implemented before the execution of the synchronous operation is completed or times out.

Therefore cancellation mechanism implementation 120 may be described in the context of a managed execution environment, although such environment is provided only as an example and is not intended to be limiting in any manner. Examples of managed execution environments may include: Visual Basic runtime execution environment; Java® Virtual Machine runtime execution environment that is used to run, e.g., Java® routines; or Common Language Runtime (CLR) to compile, e.g., Microsoft .NET™ applications into machine language before executing a calling routine.

Managed execution environments may provide routines for application programs to perform properly in an operating system because an application program may require another software system in order to execute. Thus, an application program may call one or more managed execution environment routines, which may reside between the application program and the operating system, and the managed execution environment routines may call the appropriate operating system routines.

Managed execution environments have been developed to enhance the reliability of software execution on a growing range of processing devices including servers, desktop computers, laptop computers, and a host of mobile processing devices. Managed execution environments may provide a layer of abstraction and services to an application running on a processing device (e.g., devices 105, 110, 115, and 130 described above in reference to FIG. 1). Managed execution environments may further provide such an application with capabilities that may include error handling and automatic memory management.

Accordingly, cancellation, interruption, or termination of one or more synchronous operations in a managed execution environment may call for a managed solution in view of the aforementioned race condition. The race condition may occur when a thread is shared between different synchronous operations of an application, and may cause an unintended operation to be canceled, interrupted, or otherwise terminated when an application is ignorant of the processes running therein.

More particularly, the race condition may be described better by way of an example scenario in which a cancellation operation on a first thread has been called to cancel an operation to write data that may be executing on a second thread. In this example scenario, the operation executing on the second thread may either be completed or time-out before the cancel operation on the first thread is able to cancel the operation to write data on the second thread. Thus, if at least the second thread is included as part of a thread pool, upon the completion or the time-out of the operation to write data, the second thread may be assigned a new operation for execution. For example, the second thread may be assigned a security log operation. Thus, even though the cancel operation was intended to cancel the operation to write data on the second thread, the example scenario may end with the cancellation operation on the first thread canceling the security-based security log operation that has been newly assigned to the second thread for execution. That is, a security operation on the processor may be compromised when the original intent was to merely cancel a long-running operation to write data.

A race condition scenario is described above to introduce cancellation mechanism implementation 120 by which an executing synchronous operation on a particular thread may be canceled, interrupted, or otherwise terminated as instructed by a user or automatically before execution of the operation is completed or times-out. Further, cancellation mechanism implementation 120 may enable an executing operation on a particular thread to be canceled without corrupting the overriding process. Such corruption may include canceling an operation on an unintended thread or by shutting down the entire process.

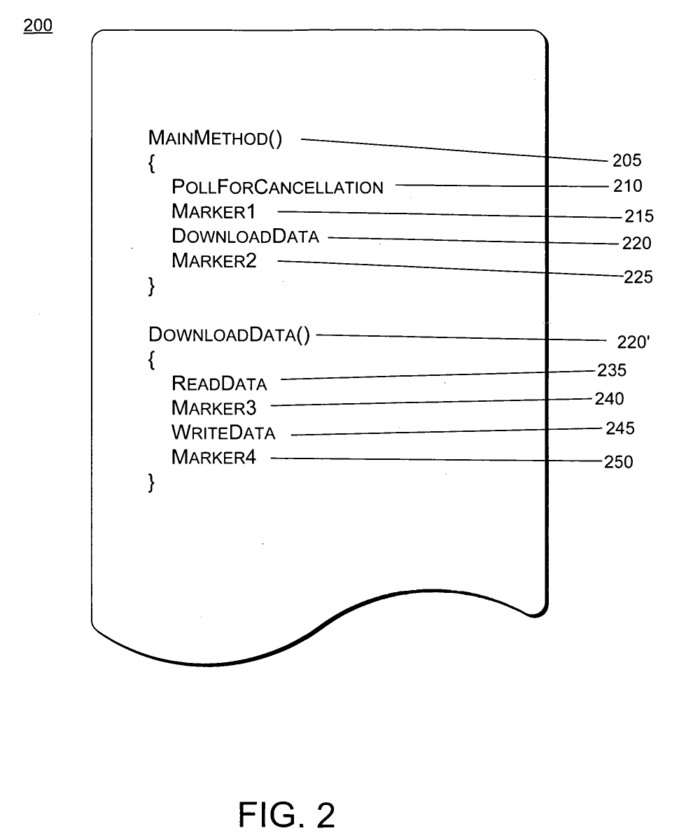

FIG. 2 shows at least a portion of example program 200 for which at least one implementation of a cancellation mechanism may be applied.

Program 200 may include identification of an operation for which cancellation may be tolerated. That is, an appropriately identified operation within program 200 may be canceled, interrupted, or otherwise terminated, after execution of the operation has commenced, without corrupting program 200 in its entirety. The identification, which may come in the form of, e.g., a marker, notation, indicator, may be provided as one or more instantiations of a cancellation API (application programming interface) class that is associated with the managed execution environment in which program 200 is to be executed. It is noted that the instantiations of the cancellation API class described below are described utilizing sample nomenclature that may be changed or modified, and is not intended to be limiting in any manner.

MainMethod 205 may represent a call to a first method within program 200. In the present example, MainMethod 205 refers to a method to download data via a network.

PollForCancellation 210 may serve as an example of the aforementioned identification of an operation for which cancellation may be tolerated. That is, for an IO operation in program 200 for which cancellation, interruption, or termination may be desired, a call may be made to PollForCancellation 210 to determine whether executable code for a desired operation in MainMethod may be canceled without corrupting or otherwise adversely affecting at least one other operation corresponding to MainMethod 205. In at least one example implementation, PollForCancellation 210 may support cancellation of MainMethod 205 without support from an underlying operating system, and further may be used to support cancellation in a CPU-intensive method that does not issue IO requests.

More particularly, a call to PollForCancellation 210 may cause a stack of potentially cancelable blocks of code (or, alternatively, cancellation markers for tracking blocks of code) to be examined to determine whether any portions of program 200 may be capable of being appropriately canceled, interrupted, or otherwise terminated. If the determination is positive, a further determination may be made as to whether a cancellation request has been made for the most recent call on the stack. If the further determination is positive, a positive value may be returned.

Marker1 215 may serve as a further example of the aforementioned identification of an operation for which cancellation, interruption, or termination may be tolerated. Marker1 210 may be any one of a method call, intermediate language (hereafter “IL”), custom attribute, metadata file format, or even a portion of executable code extracted from program 200. Marker1 215 may serve as an upper boundary of at least a portion of program 200 that may tolerate cancellation thereof without adversely affecting execution of at least one other operation corresponding to program 200. More particularly, according to at least one example implementation, if a cancellation method is called on a separate thread of program 200, a region of code having Marker1 215 as an upper boundary may be canceled, interrupted, or otherwise terminated.

DownloadData 220 may serve as an example of a cancelable operation according to one or more examples of that may be cancelable via cancellation mechanism implementation 120 (see FIG. 1). DownloadData 220 is provided only as an example of an IO operation that may be canceled for a variety of reasons, including, but not limited to, an extended amount of time without a value being returned (e.g., 2 seconds or more). That is, the implementations described herein may be utilized for long-running operations beyond IO operations including, but not limited to, processor-intensive operations such as complex mathematical computations.

Marker2 225 may serve as a further example of the aforementioned identification of an operation for which cancellation, interruption, or termination may be tolerated. Marker2 225 may also be any one of a method call, IL, custom attribute, metadata file format, or a portion of executable code extracted from program 200. Marker2 225 may serve as a lower boundary of at least a portion of program 200 (e.g., DownloadData 220) that may tolerate cancellation thereof without corrupting or adversely affecting execution of at least one other operation corresponding to program 200.

More particularly, Marker1 215 and Marker2 225 may serve as boundaries for a cancelable portion of executable code or a cancelable portion of a non-processor-intensive operation. Such upper and lower boundaries for a cancelable portion of code or operation may serve to ensure proper cancellation of a desired portion of code or an operation since one or more of such bounded portions of cancelable code or operations may be nested within other such portions. Thus, cancellation mechanism implementation 120 may provide that, if cancellation is permissible within program 200, only a desired portion of executable code or operation is canceled.

However, in alternative embodiments, appropriately identified portion of cancelable code or an operation may not always be canceled. That is, the cancelable portion of executable code or operation may not be canceled if the cancellation operation is not supported by a driver in the operating system, or is disallowed by other code higher up on a call stack within the managed execution environment (i.e., cancellation is not permitted within a portion of the program). In further alternative examples, cancellation may not be implemented if execution of the code or operation to be canceled has been completed, or if execution of the code or operation has timed out.

DownloadData 220′ may refer to the cancelable operation 220, referenced above, which may include further operations nested therein for which cancellation, interruption, or termination may or may not be tolerated in accordance with cancellation mechanism implementation 120.

ReadData 235 may refer to an operation nested within DownloadData 220 since ReadData 235 is called by DownloadData220, which itself is called within the cancelable region of code bounded by Marker1 215 and Marker2 225.

Marker3 240 may refer to an instantiation of the cancellation API class to explicitly designate an operation as being non-cancelable (e.g., SetNonCancelable). Thus, Marker3 240 may serve as a boundary to identify an operation that may be deemed as critical, and therefore may be unable to tolerate cancellation.

WriteData 245 may refer to the aforementioned operation that may be deemed to be critical, and therefore may be unable to tolerate cancellation, interruption, or termination, in accordance with cancellation mechanism implementation 120.

Marker4 250 may serve as a lower boundary of at least a portion of program 200 (e.g., WriteData 245) that may identified as not being able to tolerate cancellation thereof without corrupting or adversely affecting execution of at least one other operation corresponding to program 200.

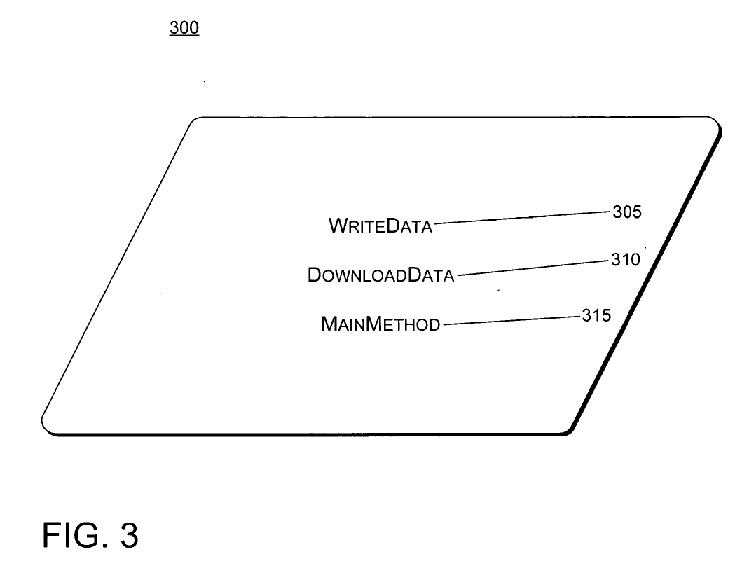

FIG. 3 may represent at least a portion of stack 300 in the managed execution environment in which program 200 (see FIG. 2) may be implemented. Thus, stack 300 is described, in part, with reference to features that are described above in correspondence with FIG. 2.

More particularly, as a call is made for MainMethod 205 in program 200, MainMethod state 315 may be added to stack 300; as a call is made to DownloadData 210 in program 200, DownloadData state 310 may be added to stack 300; and as a call is made to WriteData 220 in program 200, WriteData state 305 may be added to stack 300. Thus, state may be added to the top of stack 300 with the most recent state being on top thereof.

Stack 300 is described above to illustrate that state for a non-cancelable region of code or operation may be further up on a stack than state for a cancelable region of code or a cancelable operation. In the example of FIG. 3, non-cancelable operation WriteData state 305 is further up on stack 300 than cancelable operation DownloadData state 310. Thus, according to at least one example of cancellation mechanism implementation 120 (see FIG. 1), with non-cancelable WriteData state 305 being further up on stack 300 than cancelable DownloadData state 310, the executable code or operation for DownloadData 215 may not be canceled. However, the example implementation may provide for a cancellation request to DownloadData state 310 to be latched until no further state for non-cancelable portions of code or operations are disposed further up on stack 300.

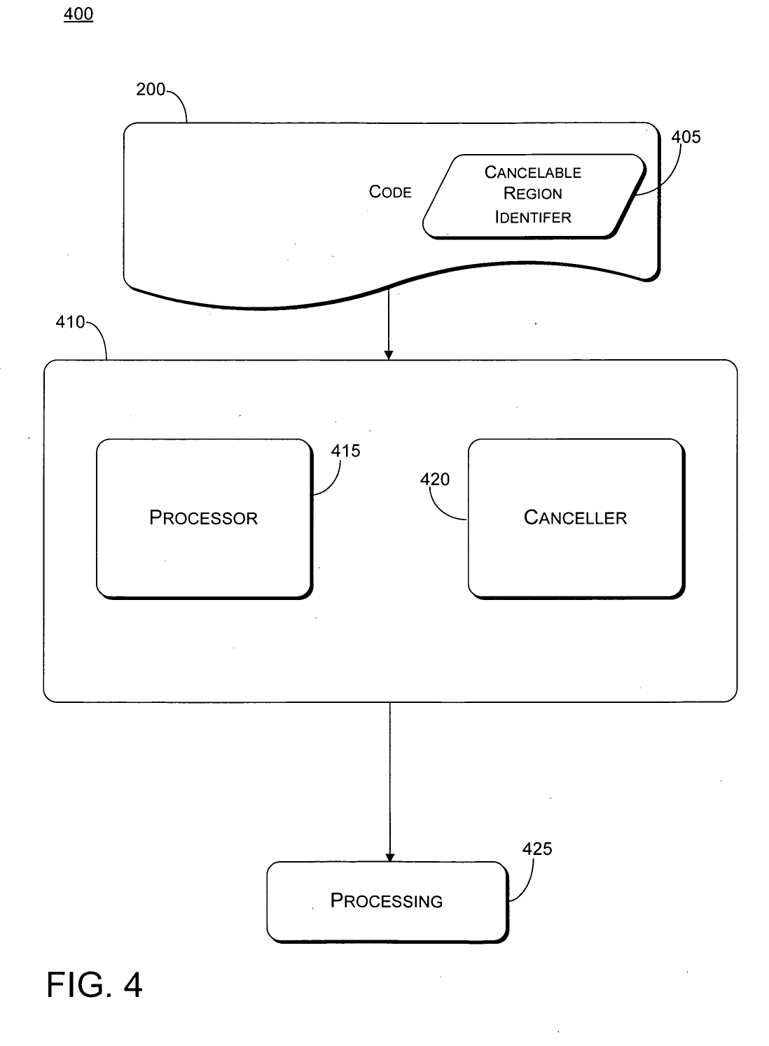

FIG. 4 shows processing flow 400 pertaining to at least one example of cancellation mechanism implementation 120 (see FIG. 1). Processing flow 400 is described, at least in part, by referring to program 200, described above in correspondence with FIG. 2.

Program 200 may be written at, or otherwise originate from, data source 130 (see FIG. 1), and provided to any one of devices 105, 110, 115 for execution in managed execution environment 410. Program 200, originating from data source device 130, may even be executed locally at device 130.

Cancelable region identifier 405 may include appropriate identification to indicate at least one cancelable or non-cancelable region of code. Referring back to the example of FIG. 2, cancelable region identifier 405 may include a return value for PollForCancellation 210 or Marker1 215 and Marker 2 225. More particularly, cancelable region identifier 405 may be at least one of, e.g., a marker, notation, or other indicator, provided as one or more instantiations of a cancellation API class that is associated with managed execution environment 410.

According to at least one example of program 200, cancelable region identifier 405 may be written into program 200 itself. However, alternative examples may contemplate cancelable region identifier 405 being provided to managed execution environment 410 separately from program 200, either via an on-line transmission or via an off-line medium.

Managed execution environment 410 may receive program 200 and cancelable region identifier 405, either in combination or separately, for execution therein.

Processor 415 may be implemented in managed execution environment 410, according to at least one example of a cancellation mechanism. More particularly, processor 415 may serve to examine a stack for processing in managed execution region 410 in order to determine whether any portions of program 200 are capable of being canceled, interrupted, or otherwise terminated, per cancelable region identifier 405. If the determination is positive, processor 415 may further determine whether a cancellation request has been made for the most recent state on the stack. If the further determination is positive, a positive value may be returned.

According to at least one alternative example, processor 415 may examine code 200 for the presence of cancelable region identifier 405 before determining whether a cancellation request has been made for the most recent state on the stack in managed execution environment 410. Similarly, a positive determine returns a positive value.

Canceller 420 may be implemented in managed execution environment 410, according to at least one example of a cancellation mechanism. More particularly, upon detection of a cancellation request, canceller 420 may cancel a portion of executable code or an operation in program 200 as identified by cancelable region identifier 405. That is, an appropriately identified portion of executable code or an appropriately identified operation for which execution has begun, may be canceled, interrupted, or otherwise terminated upon a request by a user or automatically without corrupting the overriding process, by e.g., canceling another operation on an unintended thread or by shutting down program 200 in its entirety.

However, a request for an appropriately identified portion of code or an appropriately identified operation to be canceled may not always be affirmatively answered. A cancelable portion of code or operation, identified by cancelable region identifier 405, may not be canceled if the requested cancellation operation is not supported by a driver in the operating system or a library routine within the managed execution environment, if execution of the code or operation has been completed, or if execution of the code or operation has timed out. Further, a cancelable portion of code or operation may not be canceled if state for a non-cancelable region of code or operation exists further up on a stack than state for the cancelable region of code or operation. Rather, the cancellation request may be latched until no further state for non-cancelable portions of code or operations are disposed further up the stack than state for the portion of code or operation for which cancellation is requested, as described above with reference to FIG. 3.

Processing 425 may refer to the continued processing of program 200 subsequent to a response to the aforementioned cancellation request.

The examples described above, with regard to FIGS. 1-4, may be implemented in a computing environment having components that include, but are not limited to, one or more processors, system memory, and a system bus that couples various system components. Further, the computing environment may include a variety of computer readable media that are accessible by any of the various components, and includes both volatile and non-volatile media, removable and non-removable media.

Various modules and techniques may be described herein in the general context of computer-executable instructions, such as program modules, executed by one or more computers or other devices. Generally, program modules include routines, programs, objects, components, data structures, etc. for performing particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. As a non-limiting example only, communication media includes wired media such as a wired network or direct-wired connection, and wireless media such as acoustic, RF, infrared, and other wireless media. Combinations of any of the above are also included within the scope of computer readable media.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

We claim:

1. A method, comprising:
receiving a process;
receiving an identification of an operation within the process for which cancellation is tolerated; and
canceling the operation in response to a cancellation operation.

2. A method according to claim 1, wherein the process includes executable code, and the operation and the cancellation operation are executed on separate threads.

3. A method according to claim 1, wherein the identification includes a beginning method call and ending method call that bound the operation.

4. A method according to claim 1, wherein the identification includes at least one attribute affixed to a portion of the operation.

5. A method according to claim 1, wherein the identification includes at least one indicator that cancellation of at least a portion of the operation would not corrupt the process in its entirety.

6. A method according to claim 1, wherein the operation has nested therein a sub-operation for which cancellation is not tolerated, and the method further comprises:
latching the cancellation operation until the sub-operation has been completed.

7. A method according to claim 1, wherein the process includes at least one operation for which cancellation is not tolerated.

8. A method according to claim 1, wherein the method is executed in a managed execution environment and the operation is a synchronous operation.

9. A method according to claim 1, wherein the canceling includes examining a corresponding stack to determine whether data pertaining to the operation is capable of being canceled.

10. A computer-readable medium having a data structure, the data structure comprising:
a first marker to bound at least a portion of a process for which execution may be terminated prior to completion thereof;
executable code corresponding to the portion of the process; and
a second marker to further bound the portion of the process.

11. A computer-readable medium according to claim 10, wherein either of the first and second markers includes one of a method call, intermediate language, a custom attribute, a metadata file format, or an extracted portion of the executable code.

12. A computer-readable medium according to claim 10, wherein the first and second markers bound at least a portion of a process for which execution may be terminated by at least another portion of the process.

13. A computer-readable medium according to claim 10, wherein at least a further portion of the process, provided within the portion bounded by the first and second markers, may not be terminated prior to completion thereof.

14. A computer-readable medium according to claim 10, wherein execution of the process occurs in a managed execution environment.

15. A computer-readable medium having one or more executable instructions that, when read, cause one or more processors to:
receive a call to cancel an operation on a thread;
verify that the operation is capable of being canceled;
verify that an operation that is not capable of being canceled is not executing; and
canceling execution of the operation.

16. A computer-readable medium according to claim 15, wherein the one or more instructions to receive a call to cancel the operation on the thread receive the call from another thread.

17. A computer-readable medium according to claim 15, wherein the one or more instructions to verify that the thread is capable of being canceled cause the one or more processors to poll code for the thread for at least one notation that the thread is capable of being canceled before execution thereof has been completed without corrupting another operation on the thread.

18. A computer-readable medium according to claim 15, wherein the one or more instructions to verify that a thread that is not capable of being canceled has not been called cause the one or more processors to examine a corresponding stack.

19. A computer-readable medium according to claim 15, wherein if the one or more processors is unable to verify that an operation that is not capable of being canceled is not executing, the one or more executable instructions cause one or more processors to:
latch the call to cancel the operation until completion of execution of the operation that is not capable of being canceled.

20. A computer-readable medium according to claim 15, further comprising one or more executable instructions that, when read, cause one or more processors to:
record all calls to cancel the operation.
